(19) United States
(12) Patent Application Publication
(10) Pub. No.: US 2014/0138021 A1
(43) Pub. Date: May 22, 2014

(54) PVC-FREE FLOORING AND METHOD OF MANUFACTURE

(71) Applicant: BASE KING, LLC, Dalton, GA (US)

(72) Inventor: Dennis G. Schlisner, Dalton, GA (US)

(73) Assignee: BASE KING, LLC, Dalton, GA (US)

(21) Appl. No.: 13/865,627

(22) Filed: Apr. 18, 2013

Related U.S. Application Data
(62) Division of application No. 13/354,878, filed on Jan. 20, 2012, now abandoned.

(51) Int. Cl. E04F 15/16; B32B 37/14

(52) U.S. Cl. CPC E04F 15/163; B32B 37/14
USPC 156/244.24

(57) ABSTRACT

A polyvinyl chloride free flooring, including: an upper decorative nonwoven fabric layer bonded without the use of adhesive to an intermediate extruded polymeric layer, and a extruded lower base layer bonded without the use of adhesive to the intermediate polymeric layer to provide a composite flooring that is free of polyvinyl chloride.

### FIELD

This disclosure relates to the field of flooring. More particularly, this disclosure relates to flooring that is free of polyvinyl chloride and to the manufacture thereof.

### BACKGROUND

Conventional flexible sheet flooring is provided by flooring made of polyvinyl chloride (PVC), and such floors may emit vinyl chloride, which is a volatile organic compound (VOC) and undesirable.

It is desired to provide flooring, including flexible sheet flooring, that is free of polyvinyl chloride, and the present disclosure advantageously enables the provision of flooring that is free of polyvinyl chloride.

### SUMMARY

The above and other needs are met by polyvinyl chloride free flooring.

In a preferred embodiment, the flooring includes an upper decorative nonwoven fabric layer bonded without the use of adhesive to an intermediate extruded polymeric layer, and an extruded lower base layer bonded without the use of adhesive to the intermediate polymeric layer to provide composite flooring that is free of polyvinyl chloride.

In another embodiment, the flooring includes an upper decorative nonwoven fabric layer bonded without the use of adhesive to an intermediate extruded polymeric layer comprising an ionomer, and a extruded lower base layer bonded without the use of adhesive to the intermediate polymeric layer to provide a composite flooring that is free of polyvinyl chloride.

In another aspect, the disclosure relates to a method of manufacturing polyvinyl chloride free flooring.

The method includes the steps of providing an upper decorative nonwoven fabric layer; extruding an intermediate polymeric layer using a first sheet die and joining the upper decorative nonwoven fabric layer to the extruded polymeric layer by passing the extruded polymeric layer and the nonwoven fabric layer through a first nip to provide a first composite; and extruding a lower base layer using a second sheet die having a die temperature and joining the polymeric layer of the first composite to a surface of the base layer by passing the extruded base layer and the first composite through a second nip. The second nip includes a first roller having a roller temperature of from about 30 to about 35 percent of the die temperature, and a second roller having a roller temperature greater than the temperature of the first roller, but less than about 50 percent of the temperature of the die temperature.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a perspective view of a roll of PVC-free flooring according to the disclosure.

FIG. 2 is an exploded perspective view of a section of the flooring of FIG. 1

FIG. 3 is a flow chart showing steps in the manufacture of PVC-free flooring according to the disclosure.

FIGS. 4 and 5 are representational views depicting steps in the manufacture of flooring according to the disclosure

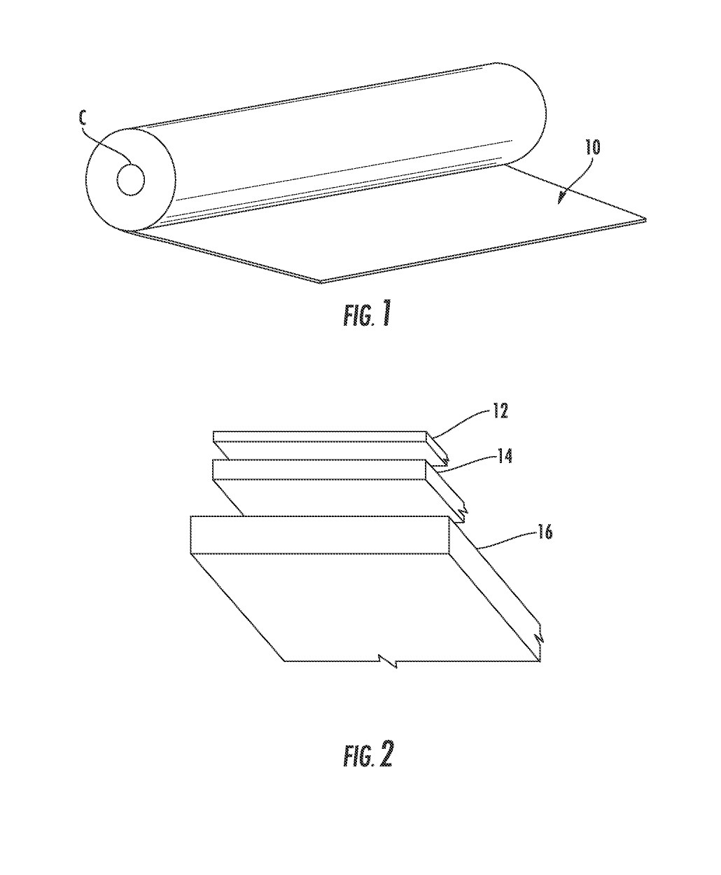

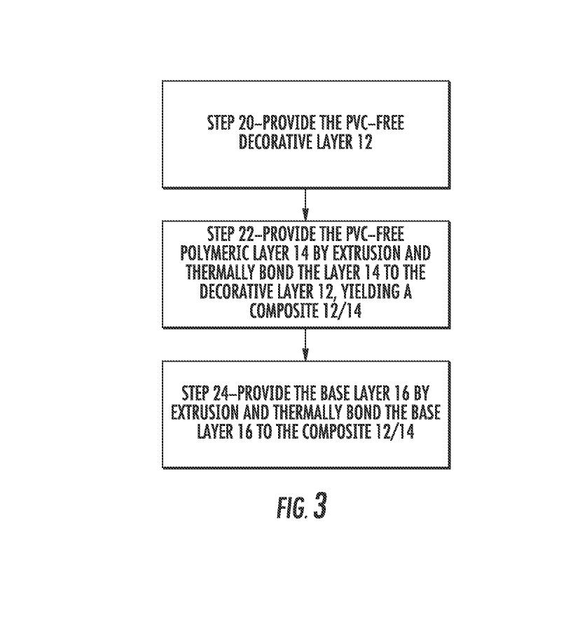

### DETAILED DESCRIPTION

With reference to the drawings, the disclosure relates to PVC-free flooring 10. The flooring 10 may be provided as a roll on a core C. The flooring 10 includes an upper decorative layer 12 that is bonded without the use of adhesive to an intermediate polymeric layer 14, and a lower base layer 16 that is bonded without the use of adhesive to the intermediate polymeric layer 14. Each of the layers 12, 14, and 16 is free of polyvinyl chloride. Examples of thicknesses are given herein for the purpose of example only, it being understood that the flooring may be provided in various dimensions.

The upper decorative layer 12 is preferably provided by a polyester non-woven fabric have a desired decorative pattern, such as wood grain, stone pattern, or other desired pattern, printed thereon as by screen printing. A preferred polyester non-woven fabric is a spunlaced nonwoven fabric available under the tradename SONTARA from E. I. Du Pont de Nemours and Company having a weight of about 1 ounce per square yard.

The PVC-free polymeric layer 14 is preferably provided by sheet extruding an ionomer, preferably a sodium ionomer thermoplastic resin available under the tradename SURLYN from E. I. Du Pont de Nemours and Company. The ionomer may be compounded with PVC-free additives, such as ultraviolet light resistance elements and the like. The polymeric layer 14 is preferably provided as a sheet having a thickness of 0.009 to about 0.018 inches, most preferably about 0.012 inches. The SURLYN sodium ionomer has a melting point of between about 150° F. and 190° F., and is typically extruded at melt temperatures of from about 365° F. to about 545° F. However, as described below, the temperature range for extruding the SURLYN ionomer is maintained in a range of 400° F. to about 475° F. for desired results in making the composite flooring 10. Other preferred ionomer thermoplastic resins include zinc, lithium, and magnesium ionomers. In addition to ionomer thermoplastic resins, other suitable PVC-free polymers include thermoplastic polyurethanes.

The PVC-free lower base layer 16 is preferably provided by sheet extruding a PVC-free thermoplastic elastomer, preferably a polyolefin-based thermoplastic elastomer. A preferred PVC-free polyolefin-based thermoplastic elastomer is available under the tradename FARAPRENE, particularly FARAPRENE 780-80A, from O'Neil Color & Compounding Corp. of Jasper, Tenn. The PVC-free thermoplastic elastomer is preferably blended with from about 15 to 25% by weight of a high density polyethylene for providing a desired rigidity. The base layer 16 is preferably provided as a sheet having a thickness of 0.050 to about 0.113 inches, most preferably about 0.068 inches. In addition to polyolefins, other suitable PVC-free thermoplastic elastomers include styrenic block copolymers, commonly referred to as SEBS, preferably containing a polypropylene modifier.

With reference to FIG. 3, the PVC-free flooring 10 may be made as by:

Step 20—Provide the PVC-free decorative layer 12 by providing the polyester non-woven fabric in a roll form and providing thereon a desired decorative pattern, such as wood grain, stone pattern, or other desired pattern, as by rotary screen printing or the like suitable for providing the desired decorative effect on the non-woven fabric.

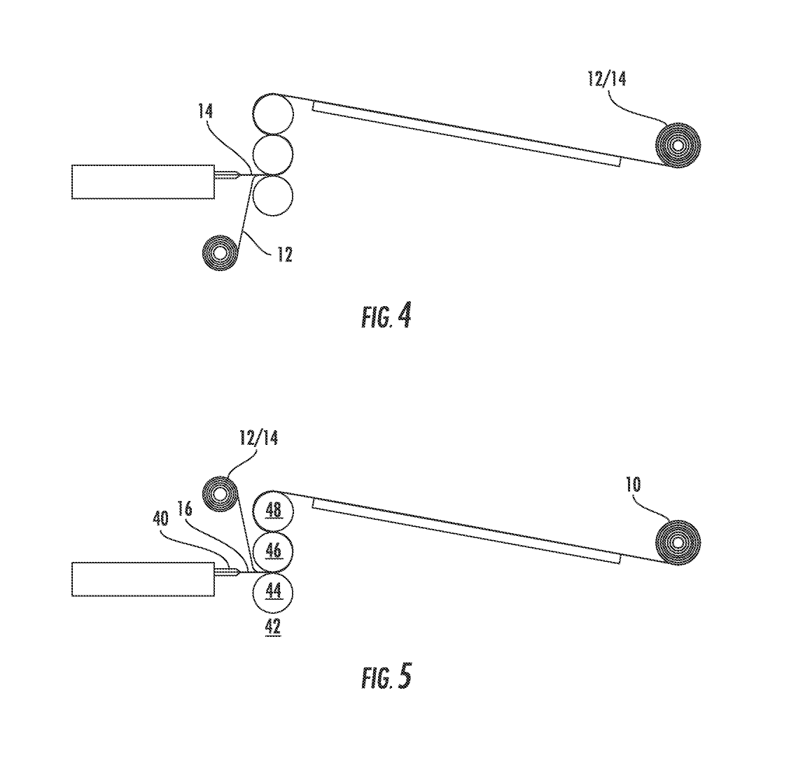

Step 22—Provide the PVC-free polymeric layer 14 by sheet extruding an ionomer at a temperature of from about 400° F. and 475° F., and thermally bonding the PVC-free polymeric layer to the PVC-free decorative layer 12 during the cooling of the polymeric layer 14, yielding a roll of the composite thereof. This process is shown in FIG. 4, with the layer 14 being extruded by an extruder and thermally bonded with the layer 14 in a cooling stack, forming a composite roll 12/14. In this regard, the preferred temperature range of between about 400° F. and 475° F. has been observed to give desired bonding between the layers formed of the preferred exemplary materials without undesirable degradation of the decorative layer 12 which can melt or otherwise be degraded if exposed to higher temperatures.

Step 24—Provide the base layer 16 by sheet extruding a PVC-free thermoplastic elastomer at a temperature of preferably about 400° F., and thermally bonding the base layer 16 to the composite 12/14 during the cooling of the base layer 16, yielding a roll of the flooring 10. This process is shown in FIG. 5, with the layer 16 being extruded by an extruder having a sheet die 40 and thermally bonded with the composite 12/14 in a cooling stack 42, forming a roll of a composite roll 12/14.

In this regard, the base layer 16 is bonded to the polymeric layer 14 with the decorative layer 12 exposed. Thermal bonding of the base layer 16 and the polymeric layer 14 without disrupting the bond between the decorative layer 12 and the polymeric layer 14 and without degrading the decorative layer 12 is accomplished by controlling the heat ratios of the sheet die 40 and the cooling stack 42. The cooling stack 42 has a bottom roller 44, a middle roller 46, and a top roller 48. The sheet die 40 is operated at a temperature of about 400° F. The bottom roller 44 is maintained at a temperature of about 130° F., and the middle roller 46 and the top roller 48 are each maintained at a temperature of about 170° F. It has been observed that this combination of temperatures allows for desired bonding of the base layer 16 and the polymeric layer 14 without disrupting the bond between the decorative layer 12 and the polymeric layer 14, and without degrading the finish and appearance of the decorative layer 12.

Thus, in the process, the cooling stack 42 is operated so as to have a temperature of the bottom roller 44 immediate the sheet die 40, which is the roller of the cooling stack 42 that directly contacts the base layer 16 as it exits the sheet die 40, at a temperature of from about 30 to about 35 percent of the temperature of the sheet die 40. Also, the middle roller 46, which is the roller of the cooling stack 42 that directly contacts the polymeric layer 14 to define a nip with the bottom roller 44 for joining the polymeric layer 14 and the base layer 16 as it exits the extruder, is maintained at a temperature greater than the temperature of the bottom roller 44, but less than about 50 percent of the temperature of the sheet die 40, and preferably between about 40 and 45 percent of the temperature of the sheet die 40. It has been observed that this combination of temperatures allows for desired bonding of the base layer 16 and the polymeric layer 14 without disrupting the bond between the decorative layer 12 and the polymeric layer 14, and without degrading the finish and appearance of the decorative layer 12.

The flooring 10 may be applied to a subfloor in a conventional manner using PVC-free adhesive and the like. However, in a preferred embodiment, a layer of double-sided adhesive, which is also PVC-free, is preferably applied to the lower surface of the base layer 16 for securing the flooring 10 to a subfloor. A preferred double-sided adhesive is a double-sided polyacrylic adhesive sheet.

Flooring according to the disclosure advantageously provides a flexible sheet flooring that is free of polyvinyl chloride. In addition, it will be appreciated that the flooring may be provided as a rigid flooring and provided in tiles and the like.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1-9. (canceled)

10. A method of making a polyvinyl chloride free flooring, comprising the steps of:
providing an upper decorative nonwoven fabric layer;
extruding an intermediate polymeric layer using a first sheet die and joining the upper decorative nonwoven fabric layer to the extruded polymeric layer by passing the extruded polymeric layer and the nonwoven fabric layer through a first nip to provide a first composite; and
extruding a lower base layer using a second sheet die having a die temperature and joining the polymeric layer of the first composite to a surface of the base layer by passing the extruded base layer and the first composite through a second nip comprising a first roller having a roller temperature of from about 30 to about 35 percent of the die temperature, and a second roller having a roller temperature greater than the temperature of the first roller, but less than about 50 percent of the temperature of the die temperature.

11. The method of claim 10, wherein the first roller directly contacts the extruded base layer.

12. A method of making a polyvinyl chloride free flooring, comprising the steps of:
providing an upper decorative nonwoven fabric layer having a decorative finish and appearance;
extruding an intermediate polymeric layer using a first sheet die and joining the upper decorative nonwoven fabric layer to the extruded polymeric layer to bond the intermediate polymeric layer to the upper decorative fabric layer by passing the extruded polymeric layer and the nonwoven fabric layer through a first nip to provide a first composite;
extruding a lower base layer using a second sheet die having a die temperature and joining the intermediate polymeric layer of the first composite to a surface of the base layer to bond the lower base layer to the intermediate polymeric layer by passing the extruded base layer and the first composite through a second nip comprising a first roller having a roller temperature lower than the die temperature, and a second roller having a roller temperature greater than the temperature of the first roller, but less than the die temperature; and
selecting and maintaining the die temperature, the temperature of the first roller, and the temperature of the second roller to enable bonding of the base layer and the intermediate polymeric layer without disrupting the bond between the decorative layer and the intermediate polymeric layer, and without causing heat degradation of the decorative finish and appearance of the decorative layer.
